(19) United States
(12) Patent Application Publication
(10) Pub. No.: US 2018/0302756 A1
(43) Pub. Date: Oct. 18, 2018

(54) Group Metadata In A Group Communications System

(71) Applicant: Telefonaktiebolaget LM Ericsson (publ), Stockholm (SE)

(72) Inventors: Magnus Tränk, Lerum (SE); Joakim Åkesson, Landvetter (SE)

(73) Assignee: Telefonaktiebolaget LM Ericsson (publ), Stockholm (SE)

(21) Appl. No.: 15/761,840

(22) PCT Filed: Sep. 13, 2016
(86) PCT No.: PCT/EP2016/071603

§ 371 Date: Mar. 21, 2018

Related U.S. Application Data
(60) Provisional application No. 62/247,574, filed on Oct. 28, 2015.

(51) Int. Cl. H04W 4/06; H04W 76/40

(52) U.S. Cl. CPC H04W 4/06; H04W 76/40

(57) ABSTRACT

A method for transmitting group metadata in a group communications system is disclosed. The method is performed by a control node, and comprises obtaining (S102) a need for transmission of group metadata for a group (160a, 160b) of client nodes in the group communications system and also broadcasting (S108) the group metadata on a multi-media broadcast multicast service, MBMS, bearer to the group of client nodes.

### INTRODUCTION

Embodiments presented herein relate to a method, a control node, a computer program, and a computer program product for transmitting group metadata in a group communications system. Embodiments presented herein further relate to a method, a client node, a computer program, and a computer program product for receiving group metadata in a group communications system.

There is provided mechanisms for transmitting group metadata in a group communications system. A method is performed by a control node. The method comprises obtaining a need for transmission of group metadata for a group of client nodes in the group communications system. The method comprises broadcasting the group metadata on a multimedia broadcast multicast service (MBMS) bearer to the group of client nodes. There is also provided mechanisms for receiving group metadata in a group communications system.

In communications networks, there may be a challenge to obtain good performance and capacity for a given communications protocol, its parameters and the physical environment in which the communications network is deployed.

For example, one example of applications available in some communications systems is group communications services. In general terms, group communication requires that the same information is delivered to multiple client nodes. In group communication systems (e.g., Push-To-Talk (PTT) systems) the client nodes receiving the same media constitute a group of client nodes. These client nodes may be located at different locations. If many client nodes are located within the same area, multicast or broadcast based transmission using e.g., Multicast-Broadcast Multimedia Services (MBMS) is efficient for communications to the group of client nodes. If client nodes are spread out over a large geographical area it can be more efficient to use unicast transmission for communications to the group of client nodes.

When using MBMS to broadcast media in a group communications system, the transmitting client node use unicast to transmit the media to the group communications system, and a control node in the group communications system use broadcast to send the media to all receiving client nodes.

When using MBMS bearers for transmission of group calls, the media is broadcasted in an MBMS service area. Multiple calls may be broadcasted at the same time, and, furthermore, a client node may receive media for multiple groups. In this case it is up to the client node to decide which call that should be listened to (e.g., played out).

When MBMS is used in group communication systems the client nodes need to be informed prior to a group call of what radio resources will be used for the broadcasted media and how the client nodes are to receive the specific group call in those resources. The process to notify the client nodes with the information to receive a group call over MBMS is denoted service announcement process.

One client node may be a member of many groups, and a client node may monitor several groups simultaneously. If there are group calls ongoing on several groups at the same time, there is a need for a function to decide which group's media that shall be delivered to the client node. This feature (known as scanning) makes a decision usually based on an assigned priority attribute for each group and client node. This priority attribute may change dynamically if a group status changes for any reason.

Client nodes need to know group metadata to be able to communicate. Some examples of group metadata are group identity, group status, group priority, and special group privileges. Some group metadata can be regarded as static (e.g., group identity) and some group metadata can be regarded as dynamic (e.g., group status). The group metadata is distributed to the client nodes with a subscribe-notify mechanism. This implies that when changes occur to the group metadata the control node in the group communications system notifies the client nodes in the group of which the group metadata was changed with the updated group metadata.

In a group communications system using unicast bearers the group communications system sends individual media streams to all receiving client nodes, and furthermore continuously makes decisions which group call to transmit.

Reference is now made to FIG. 9. FIG. 9 is a signaling diagram of the subscription-notify mechanism for group metadata according to prior art as performed between a client node 300a and a control node 200 in the group communications system. For illustrative purposes the client node 300a is assumed to belong to a group, denoted group “A”, of client nodes in the group communications system.

S901: The client node 300a performs user registration with the control node 200.

S902: The client node 300a notifies the control node 200, where the client node 300a requests to take part of the communication in a group “A” and thus to monitor group “A”.

S903: The client node 300a notifies the control node 200 to subscribe to group metadata for group “A”.

S904: The control node 200 provides a group metadata notification for group “A” to the client node 300a. This notification is sent on a unicast bearer. Furthermore, this notification is initially sent as an immediate action of the subscription of group metadata (i.e., as an immediate action of the control node 200 having received the notification in step S903).

S905: The control node 200 obtains a change in the group metadata for group “A”.

S906: The control node 200 provides a group metadata notification of the changed group metadata for group “A” to the client node 300a. This notification is sent on a unicast bearer.

As noted above, changes of group metadata will according to prior art require a notification to the client nodes of the group over unicast bearer. In order to receive a unicast bearer the client nodes need to be in radio connected mode (i.e. being able to transmit and receive). However, when serving large groups, the group communications system would typically use a MBMS bearer for media transmission since the client nodes may stay in radio idle mode, which means that the client nodes only can receive the media transmission. A group metadata change will therefore result the client nodes of the group changing state to radio connected mode at the same time. This may overload the radio network used for the group communications and drive power consumption of the physical devices running the client nodes.

Furthermore there are certain group metadata (e.g. group priority) that, when using unicast bearer, is needed by the control node in the group communications system to make a decision of which group call to transmit to a particular client node. While when using MBMS bearer for group calls, this decision must be done at the client node, since several group calls may be transmitted on the same time serving many client nodes.

Hence, there is still a need for an improved handling of group metadata in a group communications system.

An object of embodiments herein is to provide efficient handling of group metadata in a group communications system.

According to a first aspect there is presented a method for transmitting group metadata in a group communications system. The method is performed by a control node. The method comprises obtaining a need for transmission of group metadata for a group of client nodes in the group communications system. The method comprises broadcasting the group metadata on a multimedia broadcast multicast service (MBMS) bearer to the group of client nodes.

According to a second aspect there is presented a control node for transmitting group metadata in a group communications system. The control node comprises processing circuitry. The processing circuitry is configured to cause the control node to obtain a need for transmission of group metadata for a group of client nodes in the group communications system. The processing circuitry is configured to cause the control node to broadcast the group metadata on an MBMS bearer to the group of client nodes.

According to a third aspect there is presented a control node for transmitting group metadata in a group communications system. The control node comprises processing circuitry. The control node comprises a computer program product storing instructions that, when executed by the processing circuitry, causes the control node to obtain a need for transmission of group metadata for a group of client nodes in the group communications system; and broadcast the group metadata on an MBMS bearer to the group of client nodes.

According to a fourth aspect there is presented a control node for transmitting group metadata in a group communications system. The control node comprises an obtain module configured to obtain a need for transmission of group metadata for a group of client nodes in the group communications system. The control node comprises a broadcast module configured to broadcast the group metadata on an MBMS bearer to the group of client nodes.

According to a fifth aspect there is presented a computer program for transmitting group metadata in a group communications system, the computer program comprising computer program code which, when run on processing circuitry of a control node, causes the control node to obtain a need for transmission of group metadata for a group of client nodes in the group communications system; and broadcast the group metadata on an MBMS bearer to the group of client nodes.

According to a sixth aspect there is presented a method for receiving group metadata in a group communications system. The method is performed by a client node. The method comprises receiving group metadata on a broadcast MBMS bearer from a control node.

According to a seventh aspect there is presented a client node for receiving group metadata in a group communications system. The client node comprises processing circuitry. The processing circuitry is configured to cause the client node to receive group metadata on a broadcast MBMS bearer from a control node.

According to an eight aspect there is presented a client node for receiving group metadata in a group communications system. The client node comprises processing circuitry. The client node comprises a computer program product storing instructions that, when executed by the processing circuitry, causes the client node to receive group metadata on an MBMS bearer from a control node.

According to a ninth aspect there is presented a client node for receiving group metadata in a group communications system. The client node comprises a receive module configured to receive group metadata on an MBMS bearer from a control node.

According to a tenth aspect there is presented a computer program for receiving group metadata in a group communications system, the computer program comprising computer program code which, when run on processing circuitry of a client node, causes the client node to to receive group metadata on an MBMS bearer from a control node.

According to an eleventh aspect there is presented a computer program product comprising a computer program according to at least one of the fifth aspect and the tenth aspect and a computer readable storage medium on which the computer program is stored. The computer readable storage medium can be a non-transitory computer readable storage medium.

Advantageously these methods, this control node, this client node, and these computer programs provide efficient transmission and reception of group metadata in a group communications system.

Advantageously these methods, this control node, this client node, and computer programs enable client nodes to remain in radio idle mode and still receive notifications of critical group metadata changes. This is particularly advantageous when the control node is serving large groups of client nodes. Otherwise, if a large group of client nodes needs to be radio connected for a group metadata change, there is a risk for starvation of radio resources.

Advantageously, enabling client nodes to remain in radio idle mode reduces power consumption of the physical devices running the clients.

When using an MBMS bearer for media transmissions of parallel group calls, the decision on which group call to listen to needs to be taken in the client nodes. Advantageously these methods, this control node, this client node, and computer programs enable the client nodes to make such a decision; when using unicast bearer this decision is made by the control node.

Advantageously these methods, this control node, this client node, and computer programs allow the client nodes to, e.g., visualize activities in other groups than the group currently selected for media playout at the client node.

It is to be noted that any feature of the first, second, third, fourth, fifth, sixth, seventh, eight, ninth, tenth and eleventh aspects may be applied to any other aspect, wherever appropriate. Likewise, any advantage of the first aspect may equally apply to the second, third, fourth, fifth, sixth, seventh, eight, ninth, tenth, and/or eleventh aspect, respectively, and vice versa. Other objectives, features and advantages of the enclosed embodiments will be apparent from the following detailed disclosure, as well as from the drawings.

Generally, all terms used herein are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Certain embodiments of the inventive concept is now described, by way of example, with reference to the accompanying drawings, in which:

FIG. 1 is a schematic diagram illustrating a communications system according to embodiments;

FIG. 2a is a schematic diagram showing functional units of a control node according to an embodiment;

FIG. 2b is a schematic diagram showing functional modules of a control node according to an embodiment;

FIG. 3a is a schematic diagram showing functional units of a client node according to an embodiment;

FIG. 3b is a schematic diagram showing functional modules of a client node according to an embodiment;

FIG. 4 shows one example of a computer program product comprising computer readable means according to an embodiment;

FIGS. 5, 6, 7, and 8 are flowcharts of methods according to embodiments; and

FIG. 9 is a signaling diagram of a subscription-notify mechanism for group metadata according to prior art; and

FIG. 10 is a signaling diagram of a subscription-notify mechanism for group metadata according to an embodiment.

### DETAILED DESCRIPTION

Certain embodiments of the inventive concept will now be described more fully hereinafter with reference to the accompanying drawings, in which certain embodiments of the inventive concept are shown. Other embodiments comprising many different forms may be included and this disclosure should not be construed as limited to the embodiments set forth herein; rather, these embodiments are provided by way of example. Like numbers refer to like elements throughout the description. In some in Any step or feature illustrated by dashed lines may be regarded as optional.

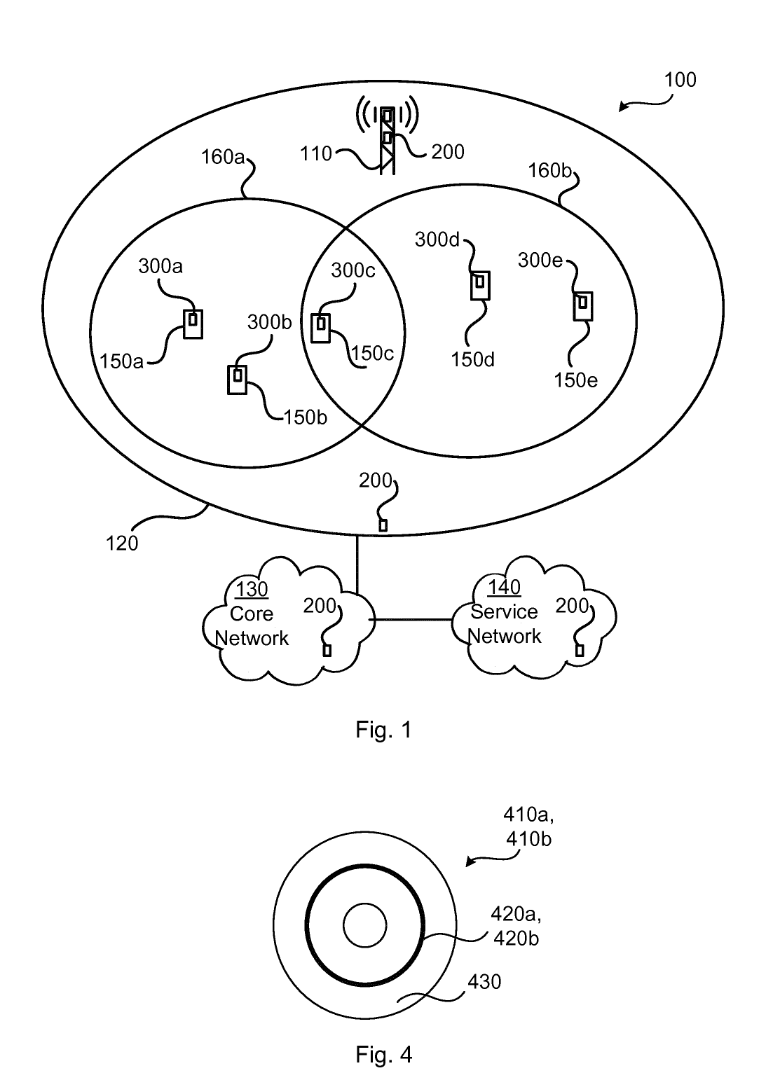

FIG. 1 is a schematic diagram illustrating a communications system 100 where embodiments presented herein can be applied. The communications system 100 is assumed to provide services for group communication may hence be regarded as a group communications system. The group communications system 100 may be a push to talk (PTT) system.

The communications system 100 comprises at least one control node 200 and at least one group 160a, 160b of client nodes 300a, 300b, 300c, 300d, 300e; the communications system 100 comprises two groups 160a, 160b, but the embodiments disclosed herein are not limited to any particular number of groups. In the schematic illustration of FIG. 1, client nodes 300a, 300b, 300c belong to group 160a, and client nodes 300c, 300d, 300e belong to group 160b. Hence, client node 300c belongs to both group 160a and group 160b.

The at least one control node 200 may be provided in, or installed on, a radio access network node 110 or in another entity or device in a radio access network 120, in an entity or device of a core network 130, or in an entity or device of a service network 140. Each client node may be provided in, or installed on, a respective wireless device 150a, 150b, 150c, 150d, 150e.

Examples of wireless devices 150a, 150b, 150c, 150d, 150e include, but are not limited to, mobile stations, mobile phones, handsets, wireless local loop phones, user equipment (UE), smartphones, laptop computers, and tablet computers. Examples of radio access network nodes 110 include, but are not limited to, radio base stations, base transceiver stations, node Bs, evolved node Bs, and access points. As the skilled person understands, the communications system 100 may comprise a plurality of radio access network nodes 110, each providing network access to a plurality of wireless devices 150a, 150b, 150c, 150d, 150e.

The herein disclosed embodiments are no limited to any particular number of radio access network nodes 110, client nodes 300a, 300b, 300c, 300d, 300e, or wireless devices 150a, 150b, 150c, 150d, 150e. In this respect it is assumed that there is at least one control node 200 and at least one group 160a, 160b of client nodes 300a, 300b, 300c, 300d, 300e.

Assume for illustrative and non-limiting purposes that there are ongoing calls in both groups 160a, 160b. When using unicast bearers the control node 200 sends individual media flows for the group calls to each client node 300a-300e. For the client node 300c being part of both groups 160a, 160b the control node 200 decides, based on groups and user attributes, which group call to transmit. When using MBMS bearers this decision must be taken by the client node 300c itself since both calls will be broadcasted to all clients 300a-300e operatively connected to the radio access network 120.

The embodiments disclosed herein relate to mechanisms for transmitting and receiving group metadata in a group communications system. In order to obtain such mechanisms there is provided a control node 200, a method performed by the control node 200, a computer program product comprising code, for example in the form of a computer program, that when run on processing circuitry of the control node 200, causes the control node 200 to perform the method. In order to obtain such mechanisms there is further provided a client node 300a, 300b, 300c, 300d, 300e, a method performed by the client node 300a, 300b, 300c, 300d, 300e, and a computer program product comprising code, for example in the form of a computer program, that when run on processing circuitry of the client node 300a, 300b, 300c, 300d, 300e, causes the client node 300a, 300b, 300c, 300d, 300e to perform the method.

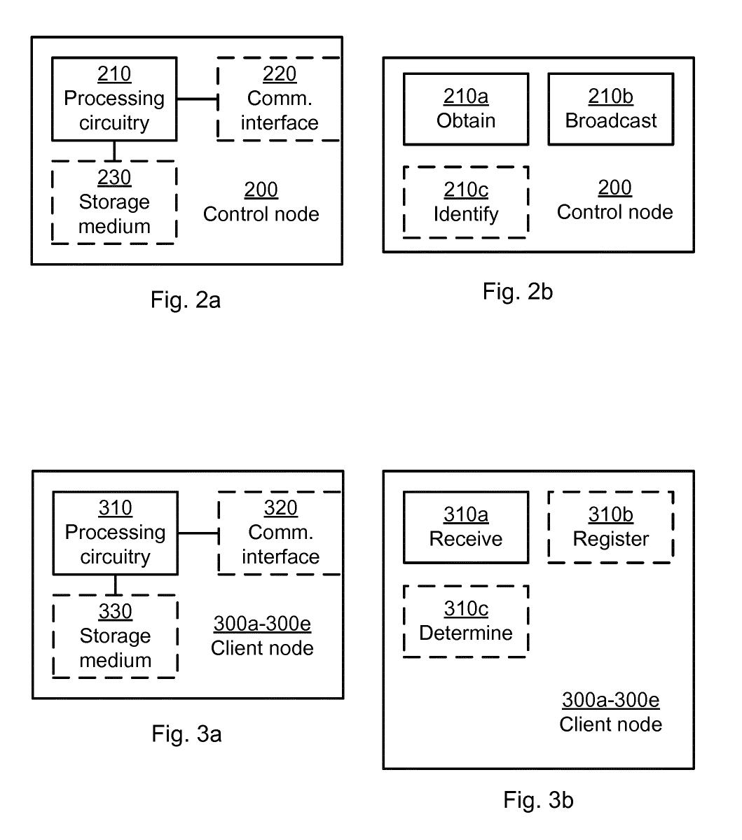

FIG. 2a schematically illustrates, in terms of a number of functional units, the components of a control node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 10a (as in FIG. 4), e.g. in the form of a storage medium 230. The processing circuitry 210 may further be provided as at least one application specific integrated circuit (ASIC), or field programmable gate array (FPGA).

Particularly, the processing circuitry 210 is configured to cause the control node 200 to perform a set of operations, or steps, S102-S108. These operations, or steps, S102-S108 will be disclosed below. For example, the storage medium 230 may store the set of operations, and the processing circuitry 210 may be configured to retrieve the set of operations from the storage medium 230 to cause the control node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The control node 200 may further comprise a communications interface 220 for communications with at least one client node 300a-300e. As such the communications interface 220 may comprise one or more transmitters and receivers, comprising analogue and digital components and a suitable number of antennas for wireless communications and ports for wireline communications.

The processing circuitry 210 controls the general operation of the control node 200 e.g. by sending data and control signals to the communications interface 220 and the storage medium 230, by receiving data and reports from the communications interface 220, and by retrieving data and instructions from the storage medium 230. Other components, as well as the related functionality, of the control node 200 are omitted in order not to obscure the concepts presented herein.

FIG. 2b schematically illustrates, in terms of a number of functional modules, the components of a control node 200 according to an embodiment. The control node 200 of FIG. 2b comprises a number of functional modules; an obtain module 210a configured to perform below step S102, and a broadcast module 210c configured to perform below step S108. The control node 200 of FIG. 2b may further comprise a number of optional functional modules, such as an identify module 210c configured to perform below steps S104, S106. The functionality of each functional module 210a-210c will be further disclosed below in the context of which the functional modules 210a-210c may be used. In general terms, each functional module 210a-210c may be implemented in hardware and/or software. Preferably, one or more or all functional modules 210a-210c may be implemented by the processing circuitry 210, possibly in cooperation with functional units 220 and/or 230. The processing circuitry 210 may thus be arranged to from the storage medium 230 fetch instructions as provided by a functional module 210a-210c and to execute these instructions, thereby performing any steps as will be disclosed herein.

The control node 200 may be provided as a standalone device or as a part of at least one further device. For example, the control node 200 may be provided in a node of the radio access network or in a node of the core network. Alternatively, functionality of the control node 200 may be distributed between at least two devices, or nodes. These at least two nodes, or devices, may either be part of the same network part (such as the radio access network or the core network) or may be spread between at least two such network parts. Some examples of where in the communications system 100 the control node 200 may be provided are illustrated in FIG. 1.

Functionality of the control node 200 may be implemented at the service layer of the protocol stack. In general terms, instructions that are required to be performed in real time may be performed in a device, or node, operatively closer to the radio access network than instructions that are not required to be performed in real time. In this respect, at least part of the control node 200 may reside in the radio access network, such as in the radio access network node, for cases when embodiments as disclosed herein are performed in real time.

Thus, a first portion of the instructions performed by the control node 200 may be executed in a first device, and a second portion of the of the instructions performed by the control node 200 may be executed in a second device; the herein disclosed embodiments are not limited to any particular number of devices on which the instructions performed by the control node 200 may be executed. Hence, the methods according to the herein disclosed embodiments are suitable to be performed by a control node 200 residing in a cloud computational environment. Therefore, although a single processing circuitry 210 is illustrated in FIG. 2a the processing circuitry 210 may be distributed among a plurality of devices, or nodes. The same applies to the functional modules 210a-210c of FIG. 2b and the computer program 420a of FIG. 4 (see below).

FIG. 3a schematically illustrates, in terms of a number of functional units, the components of a client node 300a, 300b, 300c, 300d, 300e according to an embodiment. Processing circuitry 310 is provided using any combination of one or more of a suitable central processing unit (CPU), multiprocessor, microcontroller, digital signal processor (DSP), etc., capable of executing software instructions stored in a computer program product 410b (as in FIG. 4), e.g. in the form of a storage medium 330. The processing circuitry 310 may further be provided as at least one application specific integrated circuit (ASIC), or field programmable gate array (FPGA).

Particularly, the processing circuitry 310 is configured to cause the client node 300a, 300b, 300c, 300d, 300e to perform a set of operations, or steps, S202-S204. These operations, or steps, S202-S204 will be disclosed below. For example, the storage medium 330 may store the set of operations, and the processing circuitry 310 may be configured to retrieve a portion, or all, of the set of operations from the storage medium 330 to cause the client node 300a, 300b, 300c, 300d, 300e to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The client node 300a, 300b, 300c, 300d, 300e may further comprise a communications interface 320 for communications with at least one control node 200. As such the communications interface 320 may comprise one or more transmitters and receivers, comprising analogue and digital components and a suitable number of antennas for wireless communications and ports for wireline communications.

The processing circuitry 310 controls the general operation of the client node 300a, 300b, 300c, 300d, 300e e.g. by sending data and control signals to the communications interface 320 and the storage medium 330, by receiving data and reports from the communications interface 320, and by retrieving data and instructions from the storage medium 330. Other components, as well as the related functionality, of the client node 300a, 300b, 300c, 300d, 300e are omitted in order not to obscure the concepts presented herein.

FIG. 3b schematically illustrates, in terms of a number of functional modules, the components of a client node 300a, 300b, 300c, 300d, 300e according to an embodiment. The client node 300a, 300b, 300c, 300d, 300e of FIG. 3b comprises a receive module 310a configured to perform below step S204. The client node 300a, 300b, 300c, 300d, 300e of FIG. 3b may further comprises a number of optional functional modules, such as a register module 310b configured to perform below step S202, and a determine module 310c configured to perform below step S206. The functionality of each functional module 310a-310c will be further disclosed below in the context of which the functional modules 310a-310c may be used. In general terms, each functional module 310a-310c may be implemented in hardware or in software.

Preferably, one or more or all functional modules 310a-310c may be implemented by the processing circuitry 310, possibly in cooperation with functional units 320a and/or 330. The processing circuitry 310 may thus be arranged to from the storage medium 330 fetch instructions as provided by a functional module 310a-310c and to execute these instructions, thereby performing any steps as will be disclosed hereinafter.

The client node 300a-300e may be provided as a standalone device or as a part of at least one further device. For example, the client node 300a-300e may be provided in a wireless device 150a-150e. Hence, any processing circuitry, communications interface and storage medium of the wireless device 150a-150e may be shared with the processing circuitry 310, communications interface 320 and storage medium 330 of the client node 300a-300e. It is thus not necessary for the client node 300a-300e to have its own processing circuitry 310, communications interface 320 and storage medium 330 as long as the processing circuitry, communications interface and storage medium of the wireless device 150a-150e is configured to implement the functionality of the herein disclosed client node 300a-300e.

FIG. 4 shows one example of a computer program product 410a, 410b comprising computer readable means 430. On this computer readable means 430, a computer program 420a can be stored, which computer program 420a can cause the processing circuitry 210 and thereto operatively coupled entities and devices, such as the communications interface 220 and the storage medium 230, to execute methods according to embodiments described herein. The computer program 420a and/or computer program product 410a may thus provide means for performing any steps of the control node 200 as herein disclosed. On this computer readable means 430, a computer program 420b can be stored, which computer program 420b can cause the processing circuitry 310 and thereto operatively coupled entities and devices, such as the communications interface 320 and the storage medium 330, to execute methods according to embodiments described herein. The computer program 420b and/or computer program product 410b may thus provide means for performing any steps of the client node 300a, 300b, 300c, 300d, 300e as herein disclosed.

In the example of FIG. 4, the computer program product 410a, 410b is illustrated as an optical disc, such as a CD (compact disc) or a DVD (digital versatile disc) or a Blu-Ray disc. The computer program product 410a, 410b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 420a, 420b is here schematically shown as a track on the depicted optical disk, the computer program 420a, 420b can be stored in any way which is suitable for the computer program product 410a, 410b.

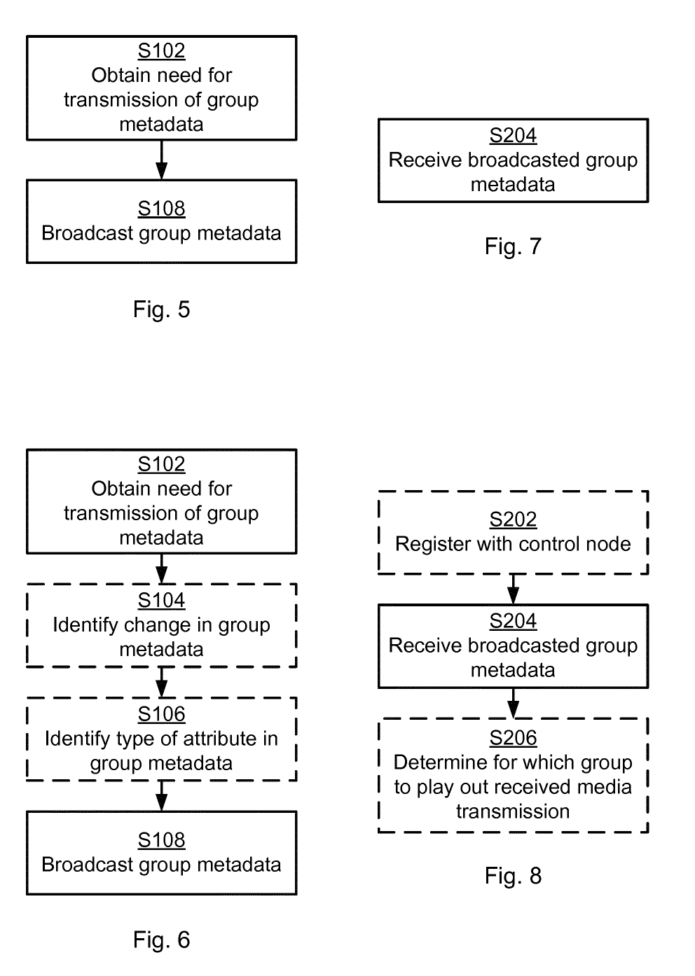

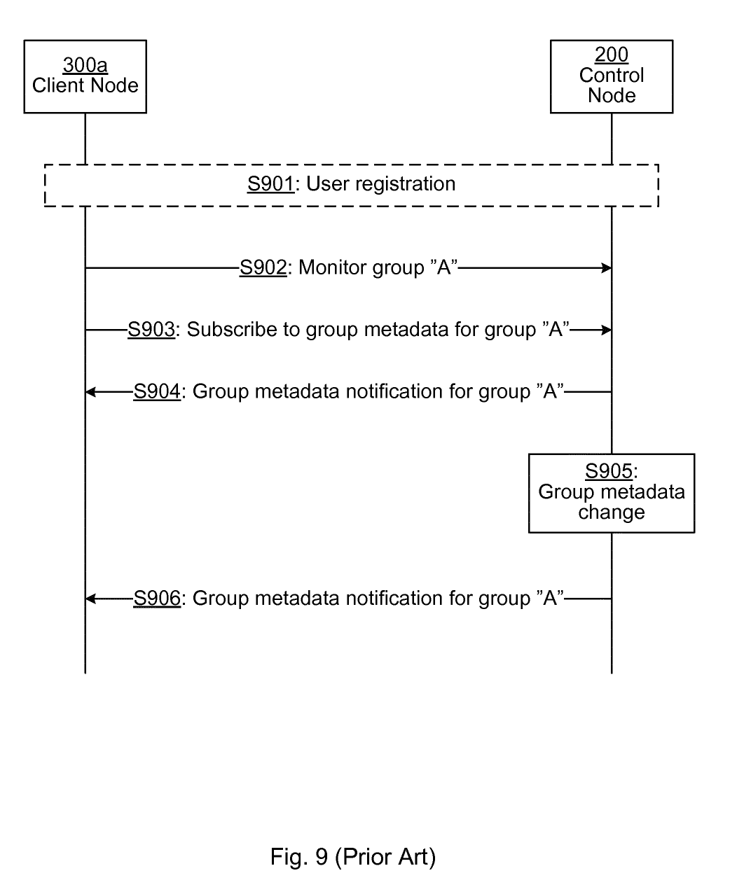

FIGS. 5 and 6 are flow charts illustrating embodiments of methods for transmitting group metadata in a group communications system 100 as performed by the control node 200. FIGS. 7 and 8 are flow charts illustrating embodiments of methods for receiving group metadata in a group communications system 100 as performed by the client node 300a, 300b, 300c, 300d, 300e. The methods are advantageously provided as computer programs 420a, 420b.

Reference is now made to FIG. 5 illustrating a method for transmitting group metadata in a group communications system 100 as performed by the control node 200 according to an embodiment.

In general terms, the control node 200 has access to group metadata for client nodes 300a-300e in the group communications system 100. The control node can thereby make decision based on the group metadata. In this respect the control node 200 manages or controls the handling of the group metadata in the group communications system 100. The control node 200 is therefore configured to, in a step S102, obtain a need for transmission of group metadata for a group 160a, 160b of client nodes 300a-300e in the group communications system 100. In this respect the obtain module 210a may comprise instructions that when executed by the control node 200 causes the processing circuitry 210, possibly in conjunction with the communications interface 220 and the storage medium 230, to obtain the need for transmission of group metadata in order for the control node 200 to perform step S102.

The control node 200 is further configured to, in a step S108, broadcast the group metadata on a multimedia broadcast multicast service (MBMS) bearer to the group 160a, 160b of client nodes 300a-300e. In this respect the broadcast module 210b may comprise instructions that when executed by the control node 200 causes the processing circuitry 210, possibly in conjunction with the communications interface 220 and the storage medium 230, to broadcast the group metadata in order for the control node 200 to perform step S108.

An MBMS bearer can thereby be used to update the client nodes 300a-300e with changes to group metadata that is critical for the client nodes 300a-300e to receive (e.g., for a client node 300a-300e to know when an MBMS bearer is used for media transmission).

Embodiments relating to further details of transmitting group metadata in a group communications system 100 will now be disclosed.

In general terms, there may be scenarios where the group metadata is retransmitted, for example so as to secure that all client nodes 300a-300e (including client nodes 300a-300e who have been out of network coverage or enters an area served by the radio access network node 110 performing the actual radio transmission of the broadcast) intended to receive the group metadata actually receive the group metadata. Hence, the group metadata is broadcast at least once on the MBMS bearer.

Reference is now made to FIG. 6 illustrating methods for transmitting group metadata in a group communications system 100 as performed by the control node 200 according to further embodiments.

There may be different ways for the control node 200 to determine what group metadata to broadcast and when to broadcast the group metadata. Different embodiments relating thereto will now be described in turn.

For example, only updated group metadata may be broadcasted. That is, according to an embodiment, the control node 200 is configured to, in a step S104, identify a change in the group metadata in relation to previous group metadata for the group 160a, 160b of client nodes 300a-300e. Hence, in at least this embodiment it is assumed that group metadata previously has been provided to the client nodes 300a-300e. The broadcasted group metadata then only comprises new or changed group metadata in relation to the previous group metadata. In this respect the identify module 210c may comprise instructions that when executed by the control node 200 causes the processing circuitry 210, possibly in conjunction with the communications interface 220 and the storage medium 230, to identify the change in the group metadata in order for the control node 200 to perform step S104.

How/when to broadcast the metadata can be based on the type of attribute in the group metadata. Examples of attributes will be provided below. Particularly, according to an embodiment the control node 200 is configured to, in a step S106, identify a type of attribute in the group metadata. A least one of how and when to broadcast the group metadata is then determined according to the type of attribute in the group metadata. In this respect the identify module 210c may comprise instructions that when executed by the control node 200 causes the processing circuitry 210, possibly in conjunction with the communications interface 220 and the storage medium 230, to identify the priority level in order for the control node 200 to perform step S106.

There may be different ways for the control node 200 to broadcast the group metadata on the MBMS bearer in step S108. In general terms, the control node 200 may perform either a separate transmission of the group metadata or a transmission of the group metadata together with other data of a media transmission. According to a first embodiment, the group metadata is broadcasted separately from a media transmission on the MBMS bearer to the group 160a, 160b of client nodes 300a-300e. According to a second embodiment, the group metadata is broadcasted jointly with a media transmission on the MBMS bearer to the group 160a, 160b of client nodes 300a-300e.

When the group metadata is broadcasted jointly with a media transmission group metadata over the MBMS bearer, the group metadata can, for example, be sent as part of the next media transmission to the client nodes 300a-300e. For example, in this case the group metadata could be part of a floor taken message sent to the client nodes 300a-300e. The floor taken message indicates that another client node 300a-300e is transmitting media to a specific group. Hence, according to an embodiment the media transmission comprises a floor taken message.

One example of when a floor taken message could include the group metadata change is if the priority of the group 160a, 160b is elevated. This may cause the client nodes 300a-300e to listen to this group 160a, 160b (i.e., to the group 160a, 160b whose priority level has been elevated) instead of any ongoing transmission to another group 160a, 160b.

There may be different examples of group metadata that can be broadcasted by the control node 200 in step S108. Examples of such group metadata include, but are not limited to, group priority information, group identity, group status, group priority, and group privileges. Each one of these examples of such group metadata defines one type of attribute of the group metadata; group priority information is one type of attribute, group identity is another type of attribute, and so on. Further, the group metadata may comprise more than one group priority attribute. These group priority attributes can be important for both the client nodes 300a-300e and the control node 200 and hence a change of the group priority attribute can be broadcasted to the client nodes 300a-300e using the MBMS bearer.

Reference is now made to FIG. 7 illustrating a method for receiving group metadata in a group communications system 100 as performed by the client node 300a, 300b, 300c, 300d, 300e according to an embodiment.

As disclosed above, the control node is configured to, in step S108, broadcast the group metadata on an MBMS bearer. This broadcast is assumed to be received by at least one of the client nodes 300a-300e. Hence, the client node 300a-300e is configured to, in a step S204, receive group metadata on a broadcast MBMS bearer from the control node 200. In this respect the receive module 310a may comprise instructions that when executed by the client node 300a-300e causes the processing circuitry 310, possibly in conjunction with the communications interface 320 and the storage medium 330, to receive the group metadata on the MBMS bearer from the control node 200 in order for the client node 300a-300e to perform step S204.

Embodiments relating to further details of receiving group metadata in a group communications system 100 will now be disclosed.

According to an embodiment the client node 300a-300e is in idle mode when receiving the group metadata.

According to an embodiment the client node 300a-300e belongs to a group 160a, 160b of client nodes 300a-300e. As disclosed above, the group metadata can then be broadcasted for the group 160a, 160b of client nodes 300a-300e.

Reference is now made to FIG. 8 illustrating methods for transmitting group metadata in a group communications system 100 as performed by the client node 300a, 300b, 300c, 300d, 300e according to further embodiments.

The client node 300a-300e may register with a group before being able to receive broadcast comprising the group metadata from the control node 200.

Hence, according to an embodiment the client node 300a-300e is configured to, in a step S202, register with the control node 200 in order to transmit or receive media in the group 160a, 160b of client nodes 300a-300e. This registering process is performed prior to the client node 300a-300e receives the group metadata. In this respect the register module 310b may comprise instructions that when executed by the client node 300a-300e causes the processing circuitry 310, possibly in conjunction with the communications interface 320 and the storage medium 330, to register the client node 300a-300e with the control node in order for the client node 300a-300e to perform step S202. The process of registering the client node 300a-300e with the control node 200 is according to the terminology of the 3rd Generation Partnership Project (3GPP) known as affiliating the client node 300a-300e with the control node 200.

As disclosed above, only updated metadata can be broadcasted by the control node 200. Hence, the client node 300a-300e can have obtained previous group metadata for the group 160a, 160b of client nodes 300a-300e before receiving the group metadata in step S202. The group metadata received in step S202 can then only comprise new or changed group metadata in relation to the previous group metadata.

As disclosed above, the group metadata can by the control node 200 be broadcasted separately from a media transmission on the MBMS bearer to the group 160a, 160b of client nodes 300a-300e and hence by the client node 300a-300e be received separately from a broadcast media transmission on the MBMS bearer from the control node 200.

As disclosed above, the group metadata can by the control node 200 be broadcasted jointly with a media transmission on the MBMS bearer to the group 160a, 160b of client nodes 300a-300e and hence by the client node 300a-300e be received jointly with a broadcast media transmission on the MBMS bearer from the control node.

As disclosed above, the broadcast media transmission can comprise a floor taken message.

As disclosed above, the group metadata can comprise group priority information, group identity, group status, and/or group privileges.

As disclosed above, the client node 300a-300e can belong to a group 160a, 160b of client nodes 300a-300e. According to an embodiment, the client node 300a-300e belongs to at least two groups 160a, 160b of client nodes 300a-300e. The group metadata is broadcasted for one of the at least two groups 160a, 160b of client nodes 300a-300e. The client node 300a-300e can then be configured to, in a step S206, determine for which of the at least two groups 160a, 160b to play out a received media transmission based on the received group metadata. In this respect the determine module 310c may comprise instructions that when executed by the client node 300a-300e causes the processing circuitry 310, possibly in conjunction with the communications interface 320 and the storage medium 330, to determine for which of the at least two groups 160a, 160b to play out the received media transmission in order for the client node 300a-300e to perform step S206. For example, the determination can be based on group priority information, group identity, group status, and/or group privileges comprised in the group metadata; the client node 300a-300e can determine to receive media transmission for the group with highest group status, highest group privileges, and/or with a particular group identity.

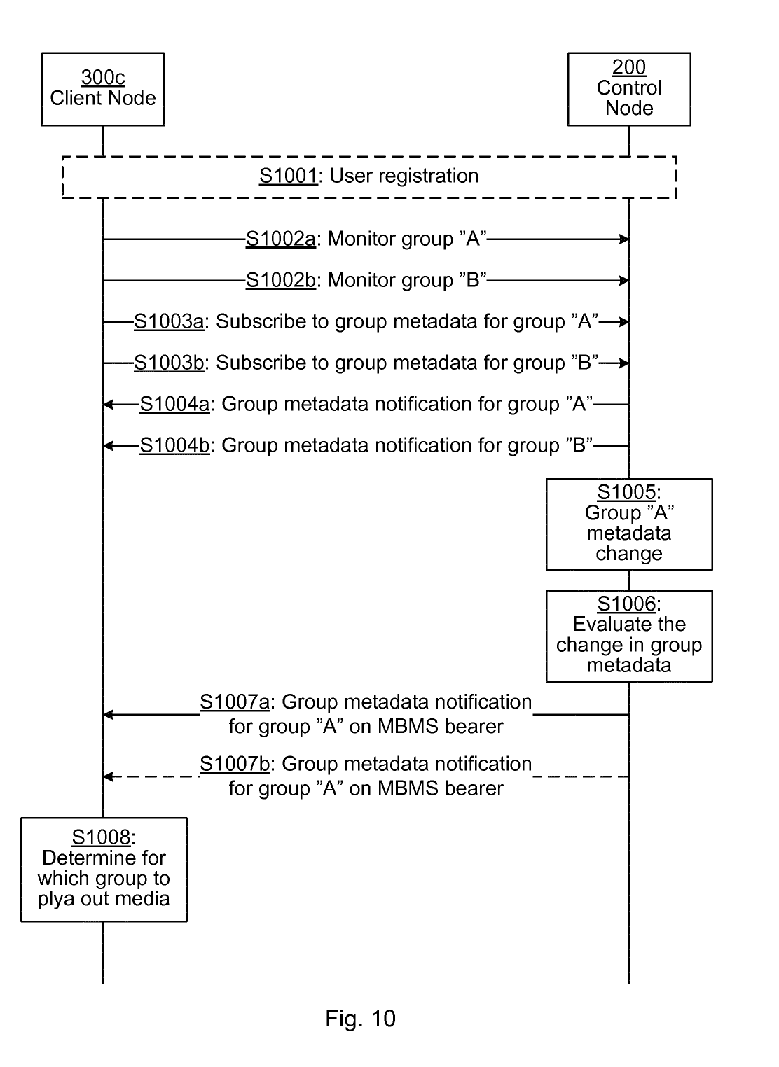

Reference is now made to FIG. 10. FIG. 10 is a signaling diagram of the subscription-notify mechanism for group metadata according to embodiments disclosed herein as performed between a client node 300c and a control node 200 in the group communications system 100. For illustrative purposes the client node 300c is assumed to belong to two groups, denoted group “A” and group “B”, of client nodes in the group communications system 100. According to the group communications system 100 of FIG. 1, group “A” can correspond to group 160a, and group “B” can correspond to group 160b.

S1001: The client node 300c performs user registration/affiliation with the control node 200.

S1002a: The client node 300c notifies the control node 200, where the client node 300c requests to take part of the communication in a group “A” and thus to monitor group “A”.

S1002b: The client node 300c notifies the control node 200, where the client node 300c requests to take part of the communication in a group “B” and thus to monitor group “B”.

S1003a: The client node 300c notifies the control node 200 to subscribe to group metadata for group “A”.

S1003b: The client node 300c notifies the control node 200 to subscribe to group metadata for group “B”.

S1004a: The control node 200 provides a group metadata notification for group “A” to the client node 300c. This notification is sent on an MBMS bearer.

S1004b: The control node 200 provides a group metadata notification for group “B” to the client node 300c. This notification is sent on an MBMS bearer.

S1005: The control node 200 obtains at least one change in the group metadata for group “A”.

S1006: The control node 200 evaluates the at least one change in the group metadata for group “A”. Some group metadata changes can require immediate or prompt notification to the client nodes whilst other group metadata changes do not require immediate or prompt notification. At least some group metadata changes can be notified over the MBMS bearer. Each of the at least one change in the group metadata is therefore evaluated and the notification over MBMS may be sent immediately or as part of the next media transmission to the client devices in group “A”.

S1007a: The control node 200 provides a group metadata notification of the changed group metadata for group “A” to the client node 300c. This notification is sent on an MBMS bearer.

S1007b: The control node 200 may provide an additional group metadata notification of the changed group metadata for group “A” to the client node 300c. This notification is sent on an MBMS bearer and notifies that the changed group metadata for group “A” will be transmitted on a unicast bearer.

S1008: The client node 300c determines for which of group “A” and group “B” to play out a received media transmission based on the received group metadata.

The particular order of steps S1002a, S1003a and S1004a on the one hand and steps S1002b, S1003b and S1004b is not of importance; all of steps S1002a, S1003a and S1004a may be performed before all of steps S1002b, S1003b and S1004b are performed, and vice versa. In this respect it is just assumed that all of steps S1001-S1007a are performed before step S1008 is performed.

Further, a further step of the control node 200 obtaining at least one change in the group metadata for group “B” (or group “A”), a further step of the control node 200 evaluating the at least one change in the group metadata for group “B” (or group “A”), a further step of the control node 200 providing a group metadata notification of the changed group metadata for group “B” (or group “A”) can also be included in this embodiment.

Although this disclosure focuses on a few embodiments, as is readily appreciated by a person skilled in the art, other embodiments than the ones disclosed above are equally possible within the scope of the inventive concept set forth herein.

### Sample Embodiments

1. A method for transmitting group metadata in a group communications system (100), the method being performed by a control node (200), the method comprising:
obtaining (S102) a need for transmission of group metadata for a group (160a, 160b) of client nodes (300a, 300b, 300c, 300d, 300e) in the group communications system (100); and
broadcasting (S108) the group metadata on a multimedia broadcast multicast service, MBMS, bearer to the group (160a, 160b) of client nodes (300a, 300b, 300c, 300d, 300e).

2. The method according to 1, further comprising:
identifying (S104) a change in the group metadata in relation to previous group metadata for the group (160a, 160b) of client nodes (300a, 300b, 300c, 300d, 300e), and wherein the broadcasted group metadata only comprises new or changed group metadata in relation to the previous group metadata.

3. The method according to 1, further comprising:
identifying (S106) a type of attribute in the group metadata, and wherein at least one of how and when to broadcast the group metadata is determined according to the type of attribute.

4. The method according to 1, wherein the group metadata is broadcasted separately from a media transmission on the MBMS bearer to the group (160a, 160b) of client nodes (300a, 300b, 300c, 300d, 300e).

5. The method according to 1, wherein the group metadata is broadcasted jointly with a media transmission on the MBMS bearer to the group (160a, 160b) of client nodes (300a, 300b, 300c, 300d, 300e).

6. The method according to 4 or 5, wherein the media transmission comprises a floor taken message.

7. The method according to 1, wherein the client nodes (300a, 300b, 300c, 300d, 300e) are in idle mode when the group metadata is broadcasted.

8. The method according to 1, wherein the group metadata comprises at least one of group priority information, group identity, group status, group priority, and group privileges.

9. A method for receiving group metadata in a group communications system (100), the method being performed by a client node (300a, 300b, 300c, 300d, 300e), the method comprising:
receiving (S204) group metadata on a broadcast multimedia broadcast multicast service, MBMS, bearer from a control node (200).

10. The method according to 9, wherein the client node (300a, 300b, 300c, 300d, 300e) belongs to a group (160a, 160b) of client nodes (300a, 300b, 300c, 300d, 300e), and wherein the group metadata is broadcasted for the group (160a, 160b) of client nodes (300a, 300b, 300c, 300d, 300e).

11. The method according to 10, further comprising:
registering (S202) with the control node (200) in order to belong to the group (160a, 160b) of client nodes (300a, 300b, 300c, 300d, 300e) prior to receiving the group metadata.

12. The method according to 10 or 11, wherein the client node (300a, 300b, 300c, 300d, 300e) has previously has obtained previous group metadata for the group (160a, 160b) of client nodes (300a, 300b, 300c, 300d, 300e), and wherein the received group metadata only comprises new or changed group metadata in relation to the previous group metadata.

13. The method according to 9, wherein the group metadata is received separately from a broadcast media transmission on the MBMS bearer from the control node (200).

14. The method according to 9, wherein the group metadata is received jointly with a broadcast media transmission on the MBMS bearer from the control node (200).

15. The method according to 13 or 14, wherein the broadcast media transmission comprises a floor taken message.

16. The method according to 9, wherein the client node (300a, 300b, 300c, 300d, 300e) is in idle mode when receiving the group metadata.

17. The method according to 9, wherein the group metadata comprises at least one of group priority information, group identity, group status, group priority, and group privileges.

18. The method according to 9, wherein the client node (300a, 300b, 300c, 300d, 300e) belongs to at least two groups (160a, 160b) of client nodes (300a, 300b, 300c, 300d, 300e), and wherein the group metadata is broadcasted for one of the at least two groups (160a, 160b) of client nodes (300a, 300b, 300c, 300d, 300e), the method further comprising:
determining (S206) for which of the at least two groups (160a, 160b) to play out a received media transmission based on the received group metadata.

19. A control node (200) for transmitting group metadata in a group communications system (100), the control node (200) comprising processing circuitry (210), the processing circuitry being configured to cause the control node (200) to:
obtain a need for transmission of group metadata for a group (160a, 160b) of client nodes (300a, 300b, 300c, 300d, 300e) in the group communications system (100); and
broadcast the group metadata on a multimedia broadcast multicast service, MBMS, bearer to the group (160a, 160b) of client nodes (300a, 300b, 300c, 300d, 300e).

20. A control node (200) for transmitting group metadata in a group communications system (100), the control node (200) comprising:
processing circuitry (210); and
a computer program product (410a) storing instructions that, when executed by the processing circuitry (210), causes the control node (200) to:
   obtain a need for transmission of group metadata for a group (160a, 160b) of client nodes (300a, 300b, 300c, 300d, 300e) in the group communications system (100); and
   broadcast the group metadata on a multimedia broadcast multicast service, MBMS, bearer to the group (160a, 160b) of client nodes (300a, 300b, 300c, 300d, 300e).

21. A control node (200) for transmitting group metadata in a group communications system (100), the control node (200) comprising:
an obtain module (210a) configured to obtain a need for transmission of group metadata for a group (160a, 160b) of client nodes (300a, 300b, 300c, 300d, 300e) in the group communications system (100); and
a broadcast module (21a) configured to broadcast the group metadata on a multimedia broadcast multicast service, MBMS, bearer to the group (160a, 160b) of client nodes (300a, 300b, 300c, 300d, 300e).

22. A client node (300a, 300b, 300c, 300d, 300e) for receiving group metadata in a group communications system (100), the client node (300a, 300b, 300c, 300d, 300e) comprising processing circuitry (₃10), the processing circuitry being configured to cause the client node (300a, 300b, 300c, 300d, 300e) to:
receive group metadata on a broadcast multimedia broadcast multicast service, MBMS, bearer from a control node (200).

23. A client node (300a, 300b, 300c, 300d, 300e) for receiving group metadata in a group communications system (100), the client node (300a, 300b, 300c, 300d, 300e) comprising:
processing circuitry (310); and
a computer program product (410b) storing instructions that, when executed by the processing circuitry (310), causes the client node (300a, 300b, 300c, 300d, 300e) to:
   receive group metadata on a broadcast multimedia broadcast multicast service, MBMS, bearer from a control node (200).

24. A client node (300a, 300b, 300c, 300d, 300e) for receiving group metadata in a group communications system (100), the client node (300a, 300b, 300c, 300d, 300e) comprising:
a receive module (310a) configured to receive group metadata on a broadcast multimedia broadcast multicast service, MBMS, bearer from a control node (200).

25. A computer program (420a) for transmitting group metadata in a group communications system (100), the computer program comprising computer code which, when run on processing circuitry (210) of a control node (200), causes the control node (200) to:
obtain (S102) a need for transmission of group metadata for a group (160a, 160b) of client nodes (300a, 300b, 300c, 300d, 300e) in the group communications system (100); and
broadcast (S108) the group metadata on a multimedia broadcast multicast service, MBMS, bearer to the group (160a, 160b) of client nodes (300a, 300b, 300c, 300d, 300e).

26. A computer program (420b) for receiving group metadata in a group communications system (100), the computer program comprising computer code which, when run on processing circuitry (310) of a client node (300a, 300b, 300c, 300d, 300e), causes the client node (300a, 300b, 300c, 300d, 300e) to:
receive (S204) group metadata on a broadcast multimedia broadcast multicast service, MBMS, bearer from a control node (200).

27. A computer program product (410a, 410b) comprising a computer program (420a, 420b) according to at least one of 25 and 26, and a computer readable storage medium (430) on which the computer program is stored.

1-27. (canceled)

28. A method for transmitting group metadata in a group communications system, the method comprising a control node:
obtaining a need for transmission of group metadata for a group of client nodes in the group communications system; and
broadcasting the group metadata on a Multimedia Broadcast Multicast Service (MBMS) bearer to the group of client nodes.

29. The method of claim 28:
further comprising identifying a change in the group metadata in relation to previous group metadata for the group of client nodes; and
wherein the broadcasted group metadata only comprises new or changed group metadata in relation to the previous group metadata.

30. The method of claim 28:
further comprising identifying a type of attribute in the group metadata; and
wherein at least one of how and when to broadcast the group metadata is determined according to the type of attribute.

31. The method of claim 28, wherein the group metadata is broadcasted separately from a media transmission on the MBMS bearer to the group of client nodes.

32. The method of claim 28, wherein the group metadata is broadcasted jointly with a media transmission on the MBMS bearer to the group of client nodes.

33. The method of claim 31, wherein the media transmission comprises a floor taken message.

34. The method of claim 28, wherein the client nodes are in idle mode when the group metadata is broadcasted.

35. The method of claim 28, wherein the group metadata comprises at least one of group priority information, group identity, group status, group priority, and group privileges.

36. A method for receiving group metadata in a group communications system, the method comprising a client node:
receiving group metadata on a broadcast Multimedia Broadcast Multicast Service (MBMS) bearer from a control node.

37. The method of claim 36:
wherein the client node belongs to a group of client nodes; and
wherein the group metadata is broadcasted for the group of client nodes.

38. The method of claim 37, further comprising registering with the control node in order to belong to the group of client nodes prior to receiving the group metadata.

39. The method of claim 37:
wherein the client node has previously has obtained previous group metadata for the group of client nodes; and
wherein the received group metadata only comprises new or changed group metadata in relation to the previous group metadata.

40. The method of claim 36, wherein the group metadata is received separately from a broadcast media transmission on the MBMS bearer from the control node.

41. The method of claim 36, wherein the group metadata is received jointly with a broadcast media transmission on the MBMS bearer from the control node.

42. The method of claim 40, wherein the broadcast media transmission comprises a floor taken message.

43. The method of claim 36, wherein the client node is in idle mode when receiving the group metadata.

44. The method of claim 36, wherein the group metadata comprises at least one of group priority information, group identity, group status, group priority, and group privileges.

45. The method of claim 36:
wherein the client node belongs to at least two groups of client nodes;
wherein the group metadata is broadcasted for one of the at least two groups of client nodes;
further comprising determining for which of the at least two groups to play out a received media transmission based on the received group metadata.

46. A control node for transmitting group metadata in a group communications system, the control node comprising:
processing circuitry; and
memory containing instructions executable by the processing circuitry whereby the control node is operative to:
obtain a need for transmission of group metadata for a group of client nodes in the group communications system; and
broadcast the group metadata on a Multimedia Broadcast Multicast Service (MBMS) bearer to the group of client nodes.

47. A client node for receiving group metadata in a group communications system, the client node comprising:
processing circuitry; and
memory containing instructions executable by the processing circuitry whereby the client node is operative to:
receive group metadata on a broadcast Multimedia Broadcast Multicast Service (MBMS) bearer from a control node.

48. A non-transitory computer readable recording medium storing a computer program product for transmitting group metadata in a group communications system, the computer program product comprising software instructions which, when run on processing circuitry of a control node, causes the control node to:
obtain a need for transmission of group metadata for a group of client nodes in the group communications system; and
broadcast the group metadata on a Multimedia Broadcast Multicast Service (MBMS) bearer to the group of client nodes.

49. A non-transitory computer readable recording medium storing a computer program product for receiving group metadata in a group communications system, the computer program product comprising software instructions which, when run on processing circuitry of a client node, causes the client node to:
receive group metadata on a broadcast Multimedia Broadcast Multicast Service (MBMS) bearer from a control node.
